(19) United States
(12) Patent Application Publication
(10) Pub. No.: US 2010/0211951 A1
(43) Pub. Date: Aug. 19, 2010

(54) IMAGE PROCESSING APPARATUS, METHOD OF CONTROLLING THE SAME, AND STORAGE MEDIUM

(75) Inventor: Fumitoshi Ito, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/703,362

(22) Filed: Feb. 10, 2010

(30) Foreign Application Priority Data
Feb. 12, 2009 (JP) 2009-029903

(51) Int. Cl. G06F 9/46

(52) U.S. Cl. 718/100; 709/204

(57) ABSTRACT

An image processing apparatus that is capable of more reliably synchronizing an execution state of a job flow set in a plurality of machines without using a management server. In the digital multi-function peripheral, a job flow list management section receives a job flow setting file in which a job flow to be executed is described, and a job execution section executes the job flow based on the received job flow setting file. A communication section notifies other digital multi-function peripherals of execution of the job flow when the job flow is executed, and notifies the other digital multi-function peripherals of termination of the job flow when the execution of the job flow is terminated.

### BACKGROUND OF THE INVENTION

1. Field of the Invention

The present invention relates to an image processing apparatus, a method of controlling the same, and a storage medium, and more particularly to an image processing apparatus configured to execute a job flow and a method of controlling the same (job flow management method).

2. Description of the Related Art

In recent years, a digital multi-function peripheral (multi-function machine) has come into actual use which includes a digital copying machine, i.e. an example of an image processing apparatus, as a basic component and is equipped with a large number of additional functions.

The digital multi-function peripheral is capable of performing facsimile communications using a scanner or a printer. The digital multi-function peripheral is also capable of developing code data sent from a computer into bitmap data and printing out the same using the printer.

Further, the digital multi-function peripheral is capable of transmitting an image scanned in by the scanner onto a network, and printing an image distributed via the network, using the printer. The digital multi-function peripheral is capable of copying using the scanner and the printer, as well.

Some types of digital multi-function peripheral provide a box function of allocating space in a storage device, such as an HDD, to virtual areas to store therein images sent from computers or images scanned in by the scanner, and thereby enabling any of the stored images to be transmitted, displayed, or printed, when needed.

Further, there has been realized a system in which a plurality of jobs to be executed using functions of such a digital multi-function peripheral are combined into a sequential flow, and at the same time, a means for invoking such combined jobs is provided, to thereby reduce the operation load on the user.

The sequential flow of collective (combined) jobs to be executed in the digital multi-function peripheral is called a job flow. It is under consideration to transmit an electronic image created by such a job flow to a workflow system, and use the transmission of the electronic image as a starting point of a workflow.

A definition of jobs included in the job flow and settings for executing the jobs is referred to as a job flow setting.

Here, if a process defined by a job flow is to be executed a plurality of times, the job flow setting should preferably be preserved even after the process is executed in accordance with the job flow. However, if the process defined by the job flow needs to be performed only once, it is not preferable that the job flow setting is preserved after the process is executed in accordance with the job flow.

Preserving the job flow setting that needs to be performed only once takes up memory space of a memory which is limited in storage capacity, and at the same time, poses a risk of mishandling the job flow, causing the job flow that needs to be preformed only once to be executed again. Further, job flows the execution of which is limited to a predetermined number of times, not alone once, also suffer from the same problems.

It is conceivable that such a job flow setting is not only used in a digital multi-function peripheral in which the job flow setting is set, but also set in a plurality of machines (digital multi-function peripherals) to cause the same process to be performed therein.

In this case, there has been proposed a technique in which a server configured to perform centralized management of the job flow is provided, and when the job flow is executed by any of the digital multi-function peripherals and then the job flow setting is deleted by the same, the job flow setting is also deleted in the other digital multi-function peripherals (see e.g. Japanese Patent Laid-Open Publication No. 2004-289654).

However, in constructing a job flow system using the above-mentioned sever for job flow management, there are the following problems to be solved:

Assume, for example, that a job flow is executed and then deleted in any of the digital multi-function peripherals.

In this job flow system, synchronization is performed via the management server, and hence if the job flow is executed simultaneously by a plurality of digital multi-function peripherals, there is the risk of executing the process more than once, which is required to be executed only once.

When a job flow is executed by one digital multi-function peripheral, no demand for deletion of the job flow setting is made to the management server until the execution of the job flow is completed. As a result, during this time period, it is impossible to prevent any of the other digital multi-function peripherals from executing the job flow.

Further, the server is required to be provided for management of job flows, and hence it takes time and labor for the user to manage the server. Nevertheless, if a digital multi-function peripheral is provided with a server function, the power needs to be constantly supplied to the digital multi-function peripheral, similarly to the server, resulting in degraded maintainability where the power cannot be casually turned off for maintenance.

### SUMMARY OF THE INVENTION

The present invention provides an image processing apparatus that is capable of more reliably synchronizing an execution state of a job flow set in a plurality of machines without using a management server, a method of controlling the same, and a storage medium.

In a first aspect of the present invention, there is provided an image processing apparatus comprising a reception unit configured to receive a job flow setting file in which a job flow to be executed is described, an execution unit configured to execute the job flow based on the received job flow setting file, and a notification unit configured to be operable when the execution unit executes the job flow, to notify other image processing apparatuses of execution of the job flow, and when the execution unit terminates the execution of the job flow, to notify the other image processing apparatuses of termination of the job flow.

In a second aspect of the present invention, there is provided a method of controlling an image processing apparatus, comprising receiving a job flow setting file in which a job flow to be executed is described, executing the job flow based on the received job flow setting file, and notifying, when executing the job flow, other image processing apparatuses of execution of the job flow, and notifying, when terminating the execution of the job flow, the other image processing apparatuses of termination of the job flow.

In a third aspect of the present invention, there is provided a computer-readable storage medium which stores a program for causing a computer to execute a method of controlling an image processing apparatus, wherein the method comprises receiving a job flow setting file in which a job flow to be executed is described, executing the job flow based on the received job flow setting file, and notifying, when executing the job flow, other image processing apparatuses of execution of the job flow, and notifying, when terminating the execution of the job flow, the other image processing apparatuses of termination of the job flow.

According to the present invention, it is possible to more reliably synchronize the execution state of the job flow set in the plurality of image processing apparatuses without using a special management server for the job flow.

Further features of the present invention will become apparent from the following description of exemplary embodiments with reference to the attached drawings.

### BRIEF DESCRIPTION OF THE DRAWINGS

FIG. 1 is a view showing the overall configuration of a workflow system where digital multi-function peripherals each as an image processing apparatus according to an embodiment of the present invention are connected to a network.

FIG. 2 is a block diagram showing the hardware configuration of each digital multi-function peripheral shown in FIG. 1.

FIG. 3 is a block diagram of software modules concerning synchronization control of a job flow for the digital multi-function peripherals.

FIG. 4 is a view showing an example of a job flow setting file (setting information) where a job flow setting for use in the digital multi-function peripherals is described.

FIG. 5 is a view illustrating an example of contents of a log record list of job flows, appearing in FIG. 3 in a table.

FIG. 6 is a diagram illustrating a screen displayed on an operating section appearing in FIG. 2 when a job flow is executed.

FIG. 7 is a flowchart of a job flow-receiving process executed by one of the digital multi-function peripherals appearing in FIG. 1 when the job flow setting file is received.

FIG. 8 is a flowchart of a display updating process executed in a step appearing in FIG. 7.

FIG. 9 is a flowchart of a job flow-deleting process executed in a step appearing in FIG. 8.

FIG. 10 is a flowchart of a periodic log-checking process for determining expiration of validity of log records of a job flow, which is executed by the one of the digital multi-function peripherals.

FIG. 11 is a flowchart of a job flow execution process for executing a job flow that requires synchronization, which is executed by the one of the digital multi-function peripherals.

FIG. 12 is a flowchart of a status-checking communication process executed in a step appearing in FIG. 11.

FIG. 13 is a flowchart of a process for status change to “executing”, which is executed in a step appearing in FIG. 11.

FIG. 14 is a flowchart of a status check-receiving process that is executed by another one of the digital multi-function peripherals appearing in FIG. 1 when a communication packet of a status check request is received thereby as a result of a step appearing in FIG. 12 which is executed by the one of the digital multi-function peripherals.

FIG. 15 is a flowchart of a status-synchronizing reception process executed by the another one of the digital multi-function peripherals when a communication packet of status synchronization communication is received from the one of the digital multi-function peripherals.

### DETAILED DESCRIPTION OF THE EMBODIMENTS

The present invention will now be described in detail below with reference to the accompanying drawings showing embodiments thereof.

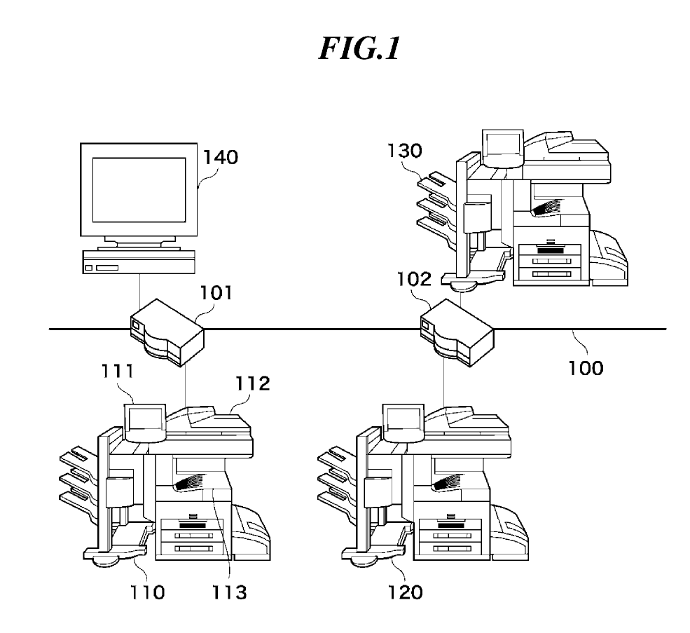

FIG. 1 is a view showing the overall configuration of a workflow system where digital multi-function peripherals as image processing apparatuses according to an embodiment of the present invention are connected to a network.

As shown in FIG. 1, digital multi-function peripherals 110, 120, and 130 (hereinafter represented by the digital multi-function peripheral 110 when deemed appropriate) are connected to a LAN 100 implemented e.g. by an Ethernet (registered trademark) via respective routers 101 and 102. In the system to which the image processing apparatus according to the present invention is applied, however, the number of connected apparatuses is by no means limited to three, i.e. the number of the illustrated ones.

Further, in the present embodiment, although the LAN is employed as connecting means, this is not limitative. For example, it is also possible to employ a desired network, such as a WAN (public communication line), a serial transmission method, such as USB, and a parallel transmission method such as Centronics or SCSI.

Also, although in the present embodiment, a description will be given by taking the digital multi-function peripheral as an example of the image processing apparatus, other image processing apparatuses than the digital multi-function peripheral, such as a general-purpose computer, may be used. Such apparatuses, however, need to have a function for executing a job flow, as described hereinafter.

The digital multi-function peripheral 110 has a copy function and a facsimile function. In addition, the digital multi-function peripheral 110 has a function for reading an original image and transmitting image data (also referred to as document data) obtained by reading the original image, to a designated apparatus on the LAN 100.

Further, the digital multi-function peripheral 110 is capable of creating an e-mail including an image as an attached file, and transmitting the e-mail using a mail server, not shown. Further, the digital multi-function peripheral 110 has a PDL (Page Description Language) interpretation function and a rendering function, and is capable of receiving PDL data from a client PC (computer) 140 as an information processing apparatus connected to the LAN 100, and printing the same.

Further, the digital multi-function peripheral 110 is capable of storing image data read by the digital multi-function peripheral 110, or PDL data designated by the client PC 140 connected to the LAN 100 in a specific area of a hard disk 204, referred to hereinafter, of the digital multi-function peripheral 110.

Further, the digital multi-function peripheral 110 is also capable of reading an original image, storing the same as digital image data in the hard disk 204, and printing the digital image data stored in the hard disk 204 as an image.

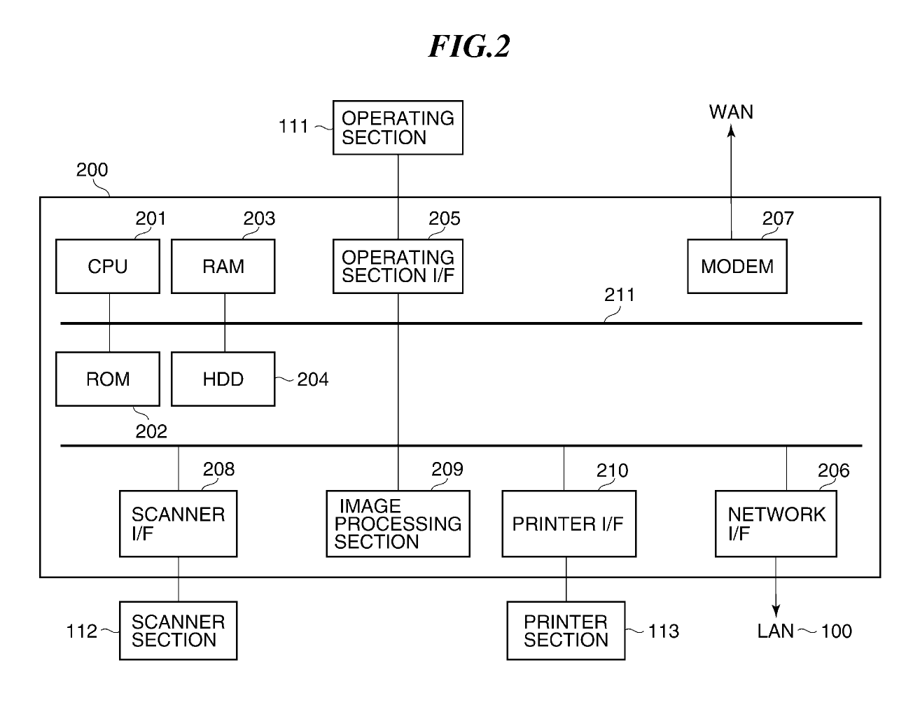

FIG. 2 is a block diagram showing the hardware configuration of each digital multi-function peripheral appearing in FIG. 1.

In FIG. 2, the digital multi-function peripheral 110 is comprised of an operating section 111, a scanner section 112, a printer section 113, and a controller 200 that performs the control of the overall operation of the digital multi-function peripheral 110. The digital multi-function peripherals 120 and 130 are also configured similarly.

The scanner section 112 inputs reflected light that is obtained by performing exposure scanning of an image on an original, to a CCD (Charge Coupled Device), thereby converting image information to an electric signal. Further, the scanner section 112 converts the electric signal to respective luminance signals of red (R), green (G), and black (B) colors, and outputs the luminance signals to the controller 200 as digital image data.

Incidentally, originals are set on a document feeder, and when the user instructs the start of scanning of the originals from the operating section 111, an instruction for scanning the originals is given from the controller 200 to the scanner section 112. When the scanner section 112 receives the instruction for scanning the originals, the scanner section 112 feeds the originals one by one from the document feeder and performs an operation for scanning each original.

Also, the method of scanning the originals may not be an automatic feeding method using the document feeder, but be a method of manually placing each original on a platen glass, not shown, and performing scanning of each original by moving an exposure section.

The printer section 113 forms image data received from the controller 200 on a sheet as an image.

Although the image forming method used in the present embodiment is an electrophotographic method using a photosensitive drum and a photosensitive belt, this is not limitative. For example, it is possible to use e.g. an inkjet method of printing out an image on a sheet by discharging ink from a fine nozzle array.

The controller 200 is electrically connected to the operating section 111, the scanner section 112, and the printer section 113, and is also connected to the LAN 100 via a network interface 206.

In other words, the digital multi-function peripheral 110 is also connected to other digital multi-function peripherals, a server, the client PC 140, and the like via the LAN 100. This makes it possible to input and output image data and information on the digital multi-function peripheral.

In the controller 200, a CPU 201 performs centralized control of access to various kinds of digital multi-function peripherals connected to the system and of access from other digital multi-function peripherals based on control programs and the like stored in a ROM 202.

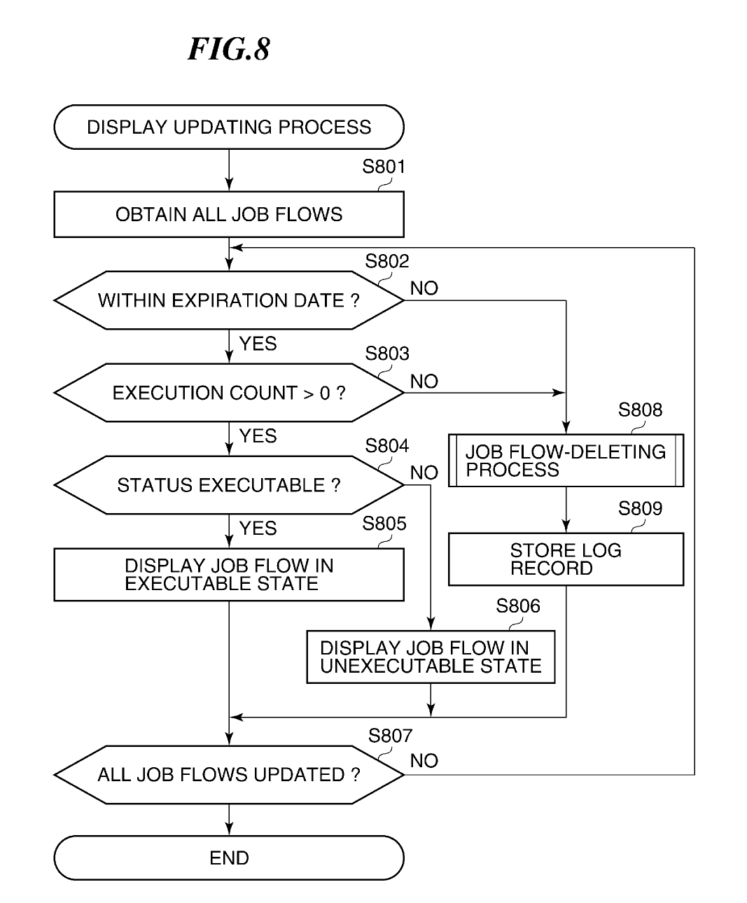

In addition, the CPU 201 also performs centralized control of various kinds of processes performed within the controller 200. This control includes execution of programs for realizing processes, described hereinafter with reference to FIGS. 8 to 15.

The ROM 202 stores a boot program for the apparatus, the programs for realizing the processes shown in FIGS. 8 to 15, and so forth. A RAM 203 is a system work memory for operating the CPU 201, and at the same time, a memory for temporarily storing image data.

The RAM 203 is formed by an area in which data stored therein is preserved by e.g. back-up power supply even after the power of the apparatus is turned off, and an area in which data stored therein is deleted when the power is turned off.

The HDD 204 is a hard disk drive capable of storing system software and image data.

An operating section interface 205 is an interface section for connecting between a system bus 211 and the operating section 111. The operating section interface 205 receives image data to be displayed on the operating section 111 from the system bus 211 and outputs the same to the operating section 111. The operating section interface 205 also receives information input from the operating section 111 and outputs the same to the system bus 211.

The network interface 206 connects between the LAN 100 and the system bus 211, and performs inputting and outputting of information. A modem 207 connects between the WAN (not shown) and the system bus 211, and performs inputting and outputting of information.

A scanner interface 208 performs correcting, processing, and editing of image data received from the scanner section 112. It should be noted that the scanner interface 208 has a function for determining whether the received image data is of a color original or of a monochrome original, whether it is of a character original or of a picture original, etc.

An image processing section 209 performs turning, compression, expansion, or the like on image data. Further, the image processing section 209 is capable of combining images stored in the HDD 204 into one image.

A printer interface 210 receives image data transmitted from the image processing section 209, and performs image formation based on the image data while referring to attribute data attached to the image data. The image data having been subjected to the image formation is delivered to the printer section 113.

An instruction from the user to the digital multi-function peripheral 110 and a presentation of information to the user may be performed, for example, via the operating section 111, or via the client PC 140 connected to the digital multi-function peripheral 110 via the LAN 100.

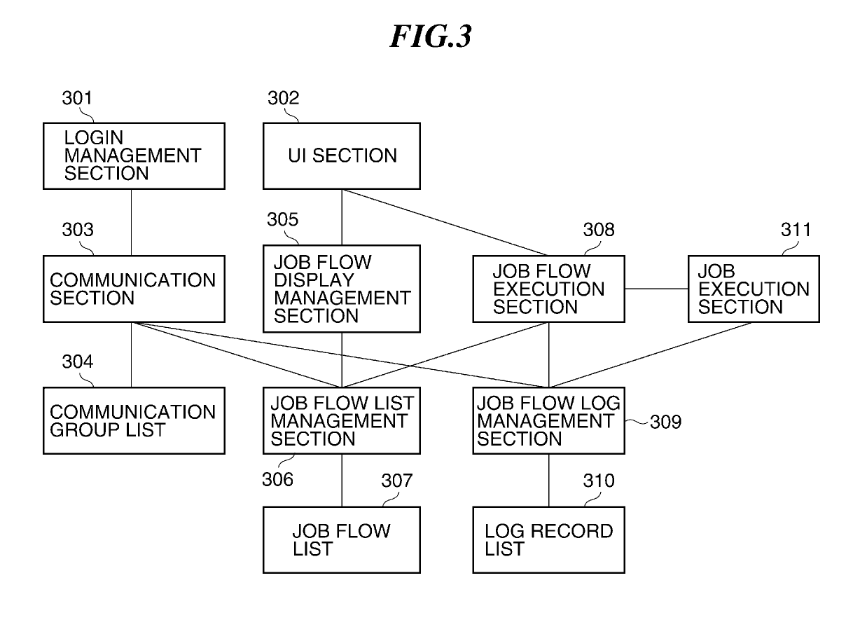

FIG. 3 is a block diagram of software modules concerning synchronization control of a job flow by the digital multi-function peripheral appearing in FIG. 1.

These software modules are executed by the CPU 201. The configuration of software modules of the digital multi-function peripherals 120 and 130 is also similar to that shown in FIG. 3.

In FIG. 3, a login management section 301 is a software module for performing user authentication in response to an authentication demand from the operating section interface 205 or the network interface 206.

A UI section 302 is a software module for performing display on the operating section 111 via the operating section interface 205, and for processing input from the operating section 111 by the user.

A communication section 303 is a software module for performing communication by operating the network interface 206 and the modem 207.

A communication group list 304 is information for managing from which digital multi-function peripheral communication packets need to be received in order to synchronize a job flow.

The present embodiment is realized by using multicasting that is a communication method of simultaneously distributing data to all members of a specific group. Therefore, it is assumed that an address of a multicast group participating in the synchronization of a job flow is described in the communication group list 304.

The multicast group is a group of communication hosts and has one IP address. The present invention, however, is not limited to multicasting. For example, the present invention can be applied to unicasting that performs one-to-one data transmission, and in such a case, unicast addresses of parties from which packets for synchronization of the job flow are permitted to be received are described in the communication group list 304.

A job flow display management section 305 is a software module for managing whether or not a job flow is to be displayed on the operating section 111 depending on a status of the job flow.

A job flow list management section 306 is a software module for managing a list and statuses of job flows.

A job flow list 307 shows the list of job flows stored in the digital multi-function peripheral 110. This job flow list is a list of job flow setting files, which is created or updated whenever a job flow setting file is received via a network or a job flow setting file is instructed to be created by the user from the operating section 111. The job flow setting file will be described hereinafter.

A job flow execution section 308 is a software module for analyzing a job flow setting file and giving an order for a processing request corresponding to the analyzed file to a job execution section 311.

A job flow log management section 309 is a software module for managing log records of job flows executed by the job execution section 311.

A log record list 310 shows a list of log records of job flows stored in the digital multi-function peripheral 110. Contents of the list will be described hereinafter.

The job execution section 311 is a software module for executing a job based on setting information on various kinds of jobs. The various kinds of jobs are each generated by a demand from the UI section 302, the communication section 303, or the job flow execution section 308.

For example, when copying or scanning is instructed by the user at the UI section 302, a job setting for the copying or scanning is passed from the UI section 302 to the job execution section 311. When a job setting is passed from one of the other digital multi-function peripherals or the client PC 140 via the communication section 303, it is processed in a similar way. How the CPU 201 causes the software modules to cooperate so as to synchronize the job flow will be described hereinafter.

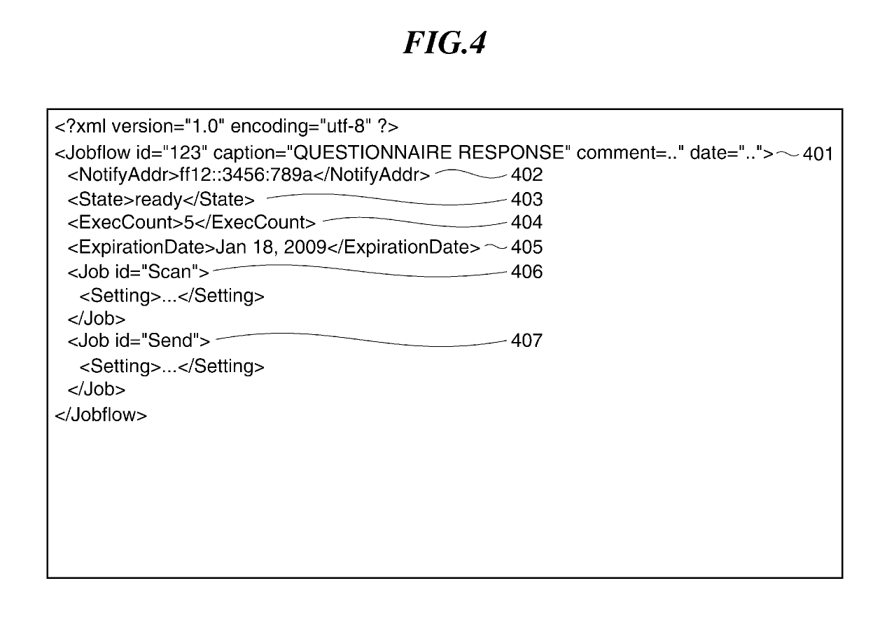

FIG. 4 is a view showing an example of a job flow setting file (setting information) where a job flow setting for use in the digital multi-function peripheral shown in FIGS. 2 and 3 is described.

FIG. 4 shows an example of a setting (job flow setting) of a job flow for “performing scanning of an image and transmitting the scanned image”. Also, this job flow is an example where the job flow can be executed five times.

In the present embodiment, the job flow setting file is assumed to be described in an XML format. However, job flow setting files may be described using a unique format instead of the XML format.

An XML element 401 shows summary information on the job flow. In the example shown in FIG. 4, the XML element 401 is comprised of a job flow ID (“123”), a job flow name (“Questionnaire Response”), comments (omitted), and the date of creation (omitted).

An XML element 402 indicates a destination to which a synchronization notification is to be transmitted for synchronization of the job flow. In the present embodiment, a multicast group address to which the synchronization notification is to be sent is described. However, the present invention is not limited to multicasting, but in the case of unicasting, for example, the present invention be applied by employing a method where all unicast addresses of distribution destinations of the flow are described.

For example, when the digital multi-function peripheral 110 and the digital multi-function peripheral 120 are to be set as the destination, the present invention can be applied by describing respective unicast addresses of the digital multi-function peripheral 110 and the digital multi-function peripheral 120. Further, when this element is not present, it indicates that synchronization is not required.

An XML element 403 indicates a status of the job flow. As the status, the XML element 403 indicates e.g. executable (“ready”), execution in progress (“executing”), unexecutable (“locked”) due to the job flow being executed in other digital multi-function peripherals.

An XML element 404 indicates a remaining number of times of execution of the job flow. It indicates that the job flow can be executed as many times as the remaining number of times of execution.

An XML element 405 indicates an expiration date of the job flow. If the expiration date has passed, it indicates that the job flow cannot be executed.

An XML element 406 indicates a scanning job as an initial job included in the job flow. Each individual job included in the job flow is referred to as an element job of the job flow. Although a scanning setting (in the case of the illustrated example) is described in a sub-element of the XML element 406, such is omitted herein.

An XML element 407 indicates a transmission job as an element job following the scanning job (in the case of the illustrated example). Although a setting required for the transmission is described in a sub-element of the XML element 407, such is omitted herein. Incidentally, it is assumed that the order of appearance of job XML elements in the job flow setting XML indicates the order of job processing.

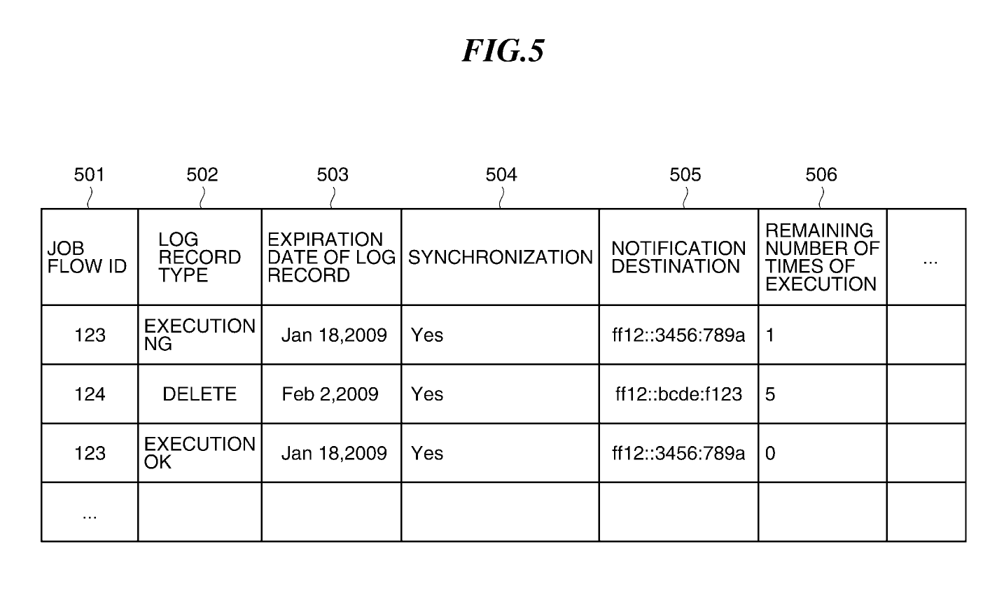

FIG. 5 is a view illustrating an example of contents of the log record list 310 of job flows shown in FIG. 3 in a table.

An entry in each box in a column 501 of the table indicates a job flow ID for identifying an executed job flow. An entry in each box in a column 502 indicates a log record type. An entry in each box in a column 503 indicates an expiration date of a log record of a job flow. The expiration date is set to an appropriate date based on the expiration date of the job flow indicated by the XML element 405 in the job flow setting file.

An entry in each box in a column 504 indicates whether or not synchronization of a job flow is required. An entry in each box in a column 505 indicates a notification destination required for notifying synchronization of a job flow. This entry has the same contents as in the XML, element 402 of an executed job flow.

An entry in each box in a column 506 is a numerical value indicating how many more times a job flow can be executed, as a result of the job flow execution heretofore. When the remaining number of times of execution is zero, it indicates that the job flow cannot be executed.

Next, a description will be given of a UI (User Interface) for executing a job flow in the digital multi-function peripheral 110.

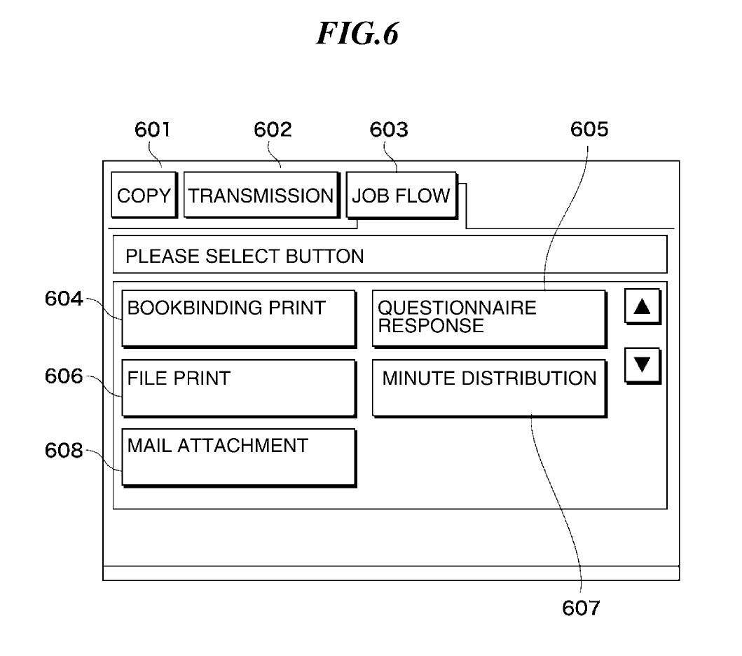

FIG. 6 is a diagram illustrating a screen displayed on the operating section shown in FIG. 2 when job flow execution is performed.

Buttons 601, 602, and 603 are buttons for switching between applications on the digital multi-function peripheral 110.

The button 601 is for displaying a screen of a copy application, the button 602 for displaying a screen of a transmission application, and the button 603 for displaying a screen of an application for executing a job flow (hereinafter referred to as the job flow application). FIG. 6 is a state in which the button 603 is pressed to display the screen of the job flow application.

Buttons 604, 605, 606, 607, and 608 are buttons displayed on the screen of the job flow application, for invoking and executing respective job flow settings associated therewith. The button 605 is associated with the job flow setting shown in FIG. 4.

Hereinafter, a description will be given of a flow of synchronization of a job flow setting, by following a sequential flow described hereafter.

The sequential flow refers to a sequence of processes “receiving a job flow setting file and displaying the same on the UI at the digital multi-function peripheral 110”, “executing a job flow at the digital multi-function peripheral 110 and synchronizing the job flow at the digital multi-function peripheral 120”, and “receiving a synchronization notification of the job flow from the digital multi-function peripheral 110 and synchronizing the job flow at the digital multi-function peripheral 120”. This flow is realized by the CPU 201 executing associated programs of the software modules.

First, a description will be given of a part of the flow from a process for receiving a job flow setting file at the digital multi-function peripheral 110 to a process for displaying the same on the screen of the digital multi-function peripheral 110.

It is assumed that the job flow setting file is created by an application on the client PC 140 in advance. In the present embodiment, description of a process therefor is omitted. In doing so, however, it is assumed that a multicast group address, an expiration date, and the number of times of execution are set for the synchronization. The job flow setting file may be created by either of the digital multi-function peripheral 110 and the digital multi-function peripheral 120 as well.

The following description will be given based on a case where a job flow-receiving process is executed by the digital multi-function peripheral 110 when the job flow setting file shown in FIG. 4 is set in the digital multi-function peripheral 110 and the digital multi-function peripheral 120.

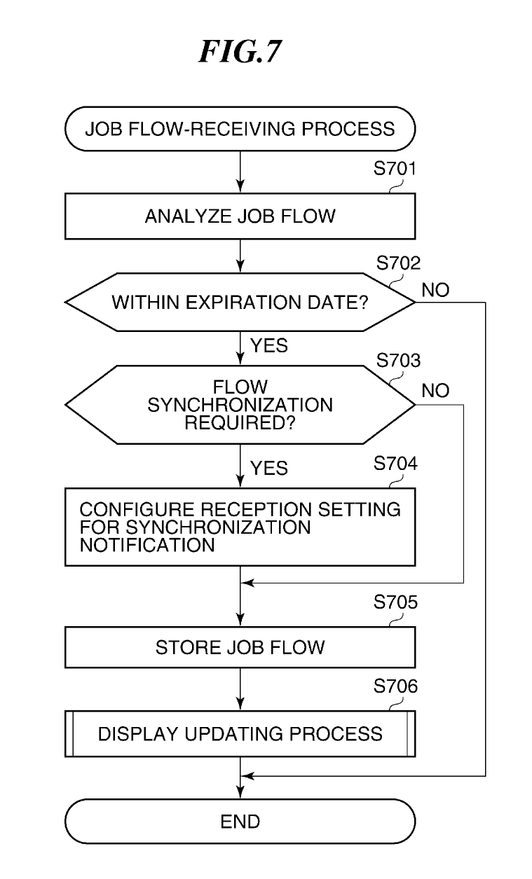

FIG. 7 is a flowchart of the job flow-receiving process executed by the digital multi-function peripheral 110 shown in FIG. 1 when the job flow setting file is received.

This job flow-receiving process is realized mainly by a program of the job flow list management section 306.

In a step S701, the job flow list management section 306 receives the job flow setting file received by the communication section 303 via the network interface 206, and reads a job flow setting described in the file.

In a step S702, the job flow list management section 306 determines whether or not the read job flow setting is within the expiration date.

If the job flow list management section 306 determines that the read job flow setting is not within the expiration date, the job flow list management section 306 terminates the job flow setting file-receiving process. If the job flow list management section 306 determines that the read job flow setting is within the expiration date, the process proceeds to a step S703.

In the step S703, the job flow list management section 306 determines whether or not the read job flow setting is one requiring synchronization.

The determination is made on the basis of whether or not a notification destination indicated by the XML element 402 is present in the job flow setting. If the job flow list management section 306 determines that the synchronization is required, the process proceeds to a step S704, whereas if not, the process proceeds to a step S705.

In the step S704, the job flow list management section 306 gives an instruction to the communication section 303 to configure a reception setting for synchronization communication (synchronization notification).

In order to configure the reception setting for synchronization communication, the communication section 303 notifies the router 101 via the network interface 206 of participation in a multicast group corresponding to the multicast group address described in the job flow setting file. Further, the communication section 303 stores the multicast group address in the communication group list.

By participating in the multicast group, it is possible to receive packets sent to the multicast group address of the network (LAN 100) for synchronization of the job flow. If unicast addresses are described in the job flow setting file, these addresses are stored in the communication group list.

In the step S705, the job flow list management section 306 adds the job flow setting to the job flow list 307 and stores the same as a file in the HDD 204.

In a step S706, the job flow list management section 306 gives an instruction to the job flow display management section 305 to update a UI display of the job flow in the UI section 302.

FIG. 8 is a flowchart of a display updating process executed in the step S706 appearing in FIG. 7.

This display updating process is realized mainly by a program of the job flow display management section 305.

In a step S801, the job flow display management section 305 instructs the job flow list management section 306 to extract a list of job flow settings stored in the HDD 204.

In a step S802, the job flow display management section 305 selects one of the job flow settings in the list extracted in the step S801 and determines whether or not it is within the expiration date. If it is within the expiration date, the process proceeds to a step S803. If not, the process proceeds to a step S808.

In the step S803, the job flow display management section 305 determines whether or not the remaining number of times of execution of the job flow of the selected job flow setting is larger than zero. If it is larger than zero, the process proceeds to a step S804, whereas if not, the process proceeds to the step S808.

In the step S804, the job flow display management section 305 determines whether or not the status of the job flow of the selected job flow setting is executable. The job flow display management section 305 refers to the value of the XML element 403 indicating the status of the job flow, and if the value is “ready”, the process proceeds to a step S805, whereas if not, the process proceeds to a step S806.

In the step S805, the job flow display management section 305 gives an instruction to the UI section 302 to display the selected job flow setting in an executable state. To display the selected job flow setting in the executable state is to display an associated GUI button in an operable manner on the screen shown in FIG. 6.

In the step S806, the job flow display management section 305 gives an instruction to the UI section 302 to display the selected job flow setting in an unexecutable state. To display the selected job flow setting in the unexecutable state is to display the associated GUI button in an inoperable manner, i.e. in a grayed-out state, on the screen shown in FIG. 6.

In a step S807, the job flow display management section 305 determines whether or not all the job flow settings are checked. If all the job flow settings are checked, the job flow display management section 305 terminates the process, whereas if not, the process returns to the step S802.

In the step S808, the job flow display management section 305 gives an instruction to the job flow list management section 306 to delete the selected job flow setting. Such a deleting process will be described hereinafter.

In a step S809, the job flow display management section 305 stores a record of deletion of the job flow setting in the log record list 310. In this case, the log record type 502 in the log record list 310 shown in FIG. 5 is described as “delete”.

The above-described processes make it possible to display executable job flow settings of which the job flows are within the expiration date in the executable state on the operating section 111. Further, it is possible to display job flow settings, which are in execution or in synchronization, in the unexecutable state.

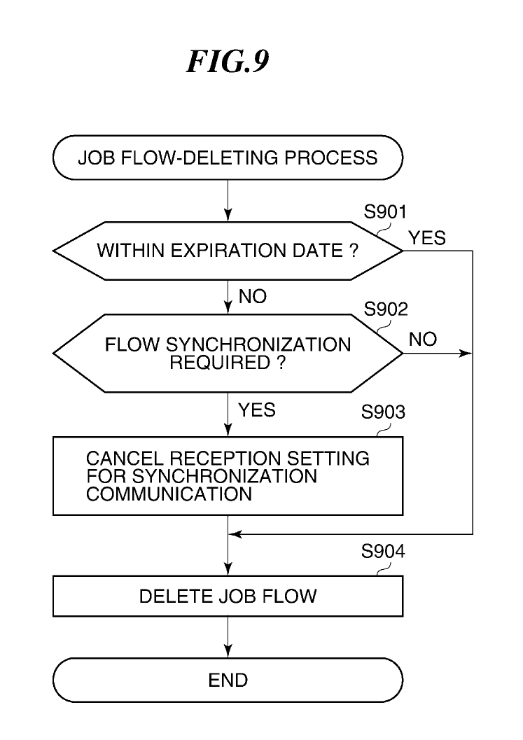

FIG. 9 is a flowchart of a job flow-deleting process executed in the step S808 shown in FIG. 8.

This job flow-deleting process is realized mainly by a program of the job flow list management section 306.

In a step S901, the job flow list management section 306 determines whether or not the selected job flow setting is within the expiration date. If it is within the expiration date, the process proceeds to a step S902. If not, the process proceeds to a step S904.

In the step S902, the job flow list management section 306 determines whether or not the selected job flow setting requires synchronization. If the synchronization needs to be performed, the process proceeds to a step S903, whereas if not, the process proceeds to the step S904.

In the step S903, the job flow list management section 306 performs a process for stopping receiving the synchronization notification corresponding to the selected job flow setting. The job flow list management section 306 instructs the communication section 303 to cancel the reception setting for synchronization communication.

In order to cancel the reception setting for synchronization communication, the communication section 303 notifies the router 101 via the network interface 206 of withdrawal from the multicast group corresponding to the multicast group address described in the job flow setting file. If unicast addresses are described in the job flow setting file, such addresses are deleted from the communication group list.

In the step S904, the job flow list management section 306 deletes the selected job flow setting from the job flow list 307 to update the information stored in the HDD 204.

Thus, the job flow-deleting process is performed. Not only when the deleting process is invoked in the step S808 appearing in FIG. 8, but also when the UI section 302 accepts an instruction for deleting a job flow setting from the user via the operating section 111, the same process is performed.

Thus far described is the flow of “receiving a job flow setting file and displaying the same on the UI at the digital multi-function peripheral 110”.

Further, in the digital multi-function peripheral 110, a periodic log-checking process for determining expiration of job flow log records is performed by the job flow log management section 309.

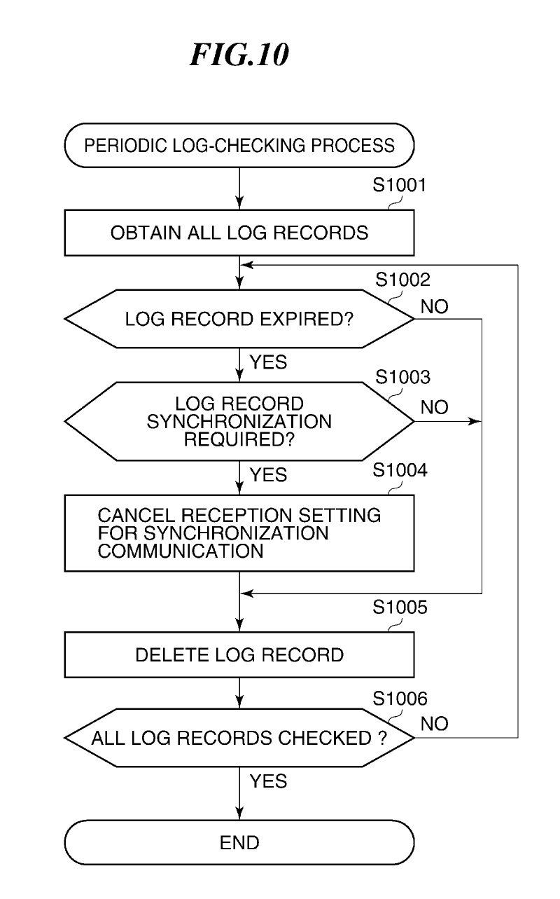

FIG. 10 is a flowchart of the periodic log-checking process for determining expiration of job flow log records, executed by the digital multi-function peripheral 110.

This periodic log-checking process is realized mainly by a program of the job flow log management section 309.

In a step S1001, the job flow log management section 309 extracts job flow log records managed in the log record list 310 of job flows.

In a step S1002, the job flow log management section 309 selects one of the job flow log records extracted in the step S1001 and determines whether or not the selected job flow log record is within the expiration date. The determination of expiration is made based on the information indicated in the column 503 shown in FIG. 5. If it is within the expiration date, the process proceeds to a step S1003. If not, the process proceeds to a step S1005.

In the step S1003, the job flow log management section 309 determines whether or not the selected job flow log record requires synchronization. This is determined based on the information indicated in the column 504 shown in FIG. 5. If the synchronization is required, the process proceeds to a step S1004, whereas if not, the process proceeds to the step S1005.

In the step S1004, the job flow log management section 309 performs a process for causing stoppage of the reception of the synchronization notification corresponding to the selected job flow log record. The job flow log management section 309 gives an instruction to the communication section 303 to cause the same to cancel the reception setting for synchronization communication.

In order to cancel the setting for receiving synchronization communication, the communication section 303 notifies the router 101 via the network interface 206 of withdrawal from the multicast group corresponding to the multicast group address described in the job flow log record. If unicast addresses are described in the job flow log record, such addresses are deleted from the communication group list.

In the step S1005, the job flow log management section 309 deletes the selected job flow log record from the log record list 310 of job flows to update information stored in the HDD 204. In doing this, all the log records corresponding to the same job flow ID are collectively deleted from the log record list 310.

In a step S1006, the job flow log management section 309 determines whether or not all the log records extracted in the step S1001 (if the log records are collectively deleted in the step S1005, the checked one having the same job flow ID is assumed to be representative of them) are checked. If all the log records extracted are checked, the job flow log management section 309 terminates the process, whereas if not, the process returns to the step S1002.

The above-described periodic process for checking expiration of the job flow log records makes it possible to stop receiving notification regarding a job flow when its expiration date has passed.

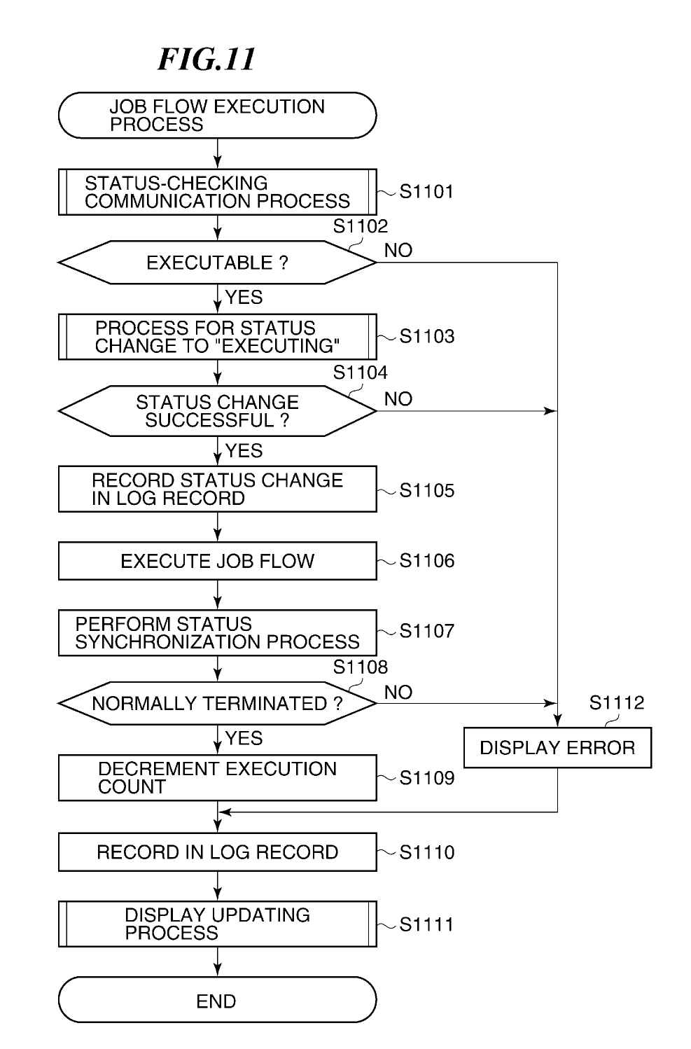

Next, a description will be given of a process for ““executing a job flow at the digital multi-function peripheral 110 and synchronizing the job flow at the digital multi-function peripheral 120”, with reference to FIG. 11.

In the digital multi-function peripheral 110, by the display updating process shown in FIG. 8, the list of job flows set in the digital multi-function peripheral 110 is displayed on the operating section 111, in a form as illustrated in FIG. 6. When the user gives an instruction to execute a job flow out of the list of job flows via the operating section 111 of the digital multi-function peripheral 110, an order to execute the job flow is given from the UI section 302 to the job flow execution section 308. The following description will be given of an example in which the execution of the job flow described in FIG. 4 is instructed.

FIG. 11 is a flowchart of a job flow execution process for executing a job flow that requires synchronization, which is executed in the present example by the digital multi-function peripheral 110.

This job flow execution process is realized mainly by a program of the job flow execution section 308.

In a step S1101, there is executed a status-checking communication process for synchronizing a job flow selected for execution and checking whether or not the job flow is executable, i.e. ready for execution, prior to the execution of the job flow. The job flow execution section 308 instructs the job flow list management section 306 to perform the status-checking communication process.

By performing the status-checking communication process, even if a job flow starts to be executed by the digital multi-function peripheral 120 when the power of the digital multi-function peripheral 110 is off, it is possible to synchronize the status and remaining number of times of execution of the job flow. Details of the status-checking communication process will be described hereinafter.

In a step S1102, the job flow execution section 308 determines whether or not the job flow is executable based on the result of the status-checking communication process in the step S1101. If the job flow is executable, the process proceeds to a step S1103, whereas if not, the process proceeds to a step S1112.

In the step S1103, a process for status change to “executing” is executed whereby the job flow execution section 308 synchronizes the status of the job flow to change the same to the “executing” status. Details of the process for status change to “executing” will be described hereinafter.

In a step S1104, the job flow execution section 308 determines whether or not the status change to the “executing” status in the step S1103 is successful. If the status change is successful, the process proceeds to a step S1105, whereas if not, the process proceeds to the step S1112.

In the step S1105, the job flow execution section 308 performs notification of the result to the job flow log management section 309 to record the status change in a log record.

In a step S1106, the job flow execution section 308 passes job settings to the job execution section 311 in the order of jobs set in the job flow, to have the jobs executed.

More specifically, based on the job settings, the job execution section 311 operates e.g. the scanner section 112 if a job to be executed this time is a scanning job, or the printer section 113 if the job to be executed this time is a printing job, to execute the job. Description of details of job execution is omitted.

In a step S1107, the job flow execution section 308 performs a status synchronization communication process in order to synchronize the status of the job flow to a state corresponding to the termination of execution of the job flow. To this end, the job flow execution section 308 instructs the communication section 303 to perform status synchronization communication.

More specifically, the communication section 303 notifies the multicast group address described in any of the associated job flow log record via the network interface 206 to request the status of the job flow to be synchronized to the “ready” status, which means that the execution of the job flow has been terminated. If unicast addresses are described in the job flow log record, a similar communication is performed to each address. The remaining number of times of execution, notified at this time, depends on the result of job flow execution. In other words, if the job flow is terminated by an error or cancellation, the remaining number of times of execution is not decremented.

In a step S1108, the job flow execution section 308 determines whether the job flow is properly terminated from the result of each job execution in the step S1106. If the job flow is properly terminated, the process proceeds to a step S1109. If not, the process proceeds to the step S1112.

In the step S1109, the job flow execution section 308 decrements the remaining number of times of execution described in the job flow setting. The job flow execution section 308 gives an instruction to the job flow list management section 306 to decrement the remaining number of times of execution of the associated job flow to update information in the job flow list 307.

In a step S1110, the job flow execution section 308 records the result of job flow execution in a log record. More specifically, the job flow execution section 308 notifies the job flow log management section 309 of the result of job flow execution, and the job flow log management section 309 updates the log record list 310 by adding the log record.

In a step S1111, the job flow execution section 308 performs the display updating process described with reference to FIG. 8 so as to cause the status and remaining number of times of execution of the job flow to be reflected on the UI display.

The step S1112 corresponds to a case of execution of exception handling in the job flow execution process. The UI section 302 displays contents of an error on the operating section 111 in accordance with each exceptional condition.

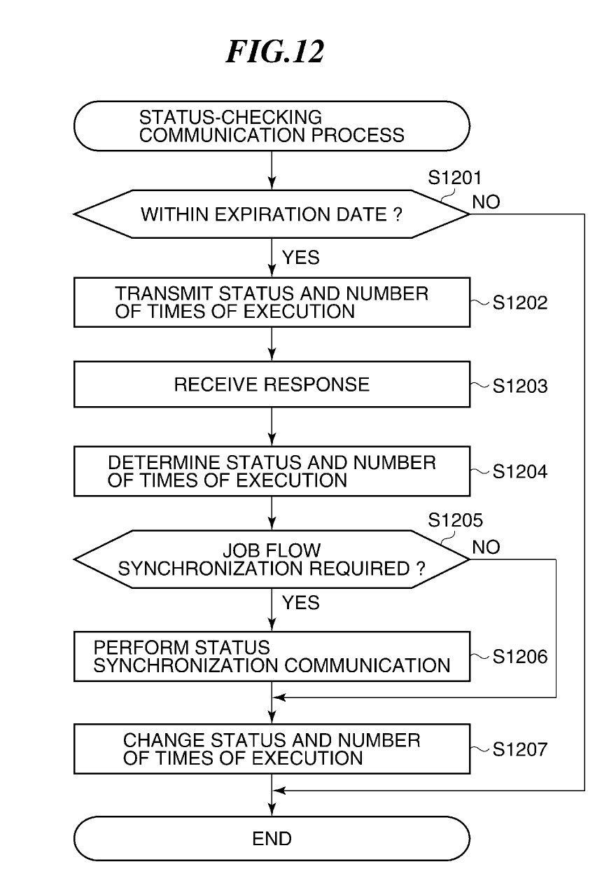

FIG. 12 is a flowchart of the status-checking communication process executed in the step S1101 shown in FIG. 11.

The status-checking communication process is realized mainly by a program of the job flow list management section 306.

In a step S1201, the job flow list management section 306 determines whether or not the job flow setting file to be executed is within the expiration date. If the job flow list management section 306 determines that the job flow setting file is not within the expiration date, the result of status check is set to “unexecutable”, followed by terminating the process. If the job flow list management section 306 determines that it is within the expiration date, the process proceeds to a step S1202.

In the step S1202, the job flow list management section 306 gives an instruction to the communication section 303 to perform a communication process for status inquiry. The job flow list management section 306 instructs the communication section 303 to notify a status check request.

The communication section 303 sends the status check request for checking the status of the job flow to the multicast group address described in the job flow log via the network interface 206. If unicast addresses are described in the job flow log, a similar communication is performed to each of the addresses.

Each digital multi-function peripheral having received this request sends back the status and remaining number of times of execution of the job flow in the job flow setting stored therein to the digital multi-function peripheral from which the request was sent. This process will be described hereinafter.

In a step S1203, the communication section 303 receives such responses to the status check request sent in the step S1202 from other digital multi-function peripherals via the network interface 206.

In the present embodiment, the same job flow setting is set in the digital multi-function peripheral 110 and the digital multi-function peripheral 120, and hence the digital multi-function peripheral 110 receives a response to the status check request from the digital multi-function peripheral 120. Assuming that the same job flow setting is set also in the digital multi-function peripheral 130, the digital multi-function peripheral 110 receives a response from the digital multi-function peripheral 130 as well.

In a step S1204, the job flow list management section 306 determines the status and remaining number of times of execution of the target job flow from the responses received in the step S1203. As a criterion of determination, if any of the received responses indicates that the status of the job flow is executable, or the remaining numbers of times of execution thereof is zero, the result of status check is set to “unexecutable”.

By this process, for example, even if the job flow setting is deleted in another digital multi-function peripheral, or if the job flow is about to be executed in the same timing in which the job flow is being executed by another digital multi-function peripheral, it is possible to prevent the execution of the job flow from being started.

In a step S1205, the job flow list management section 306 determines whether or not synchronization of the job flow is required, based on the result of determination made in the step S1204. As a criterion of determination, if the responses received from a plurality of digital multi-function peripherals are different in the status or remaining number of times of execution of the job flow, the job flow list management section 306 determines that synchronization is required between them. If the job flow list management section 306 determines that the synchronization is required, the process proceeds to a step S1206, whereas if not, the process proceeds to a step S1207.

In the step S1206, the job flow list management section 306 performs the status synchronization communication process for synchronizing the status and remaining number of times of execution of the job flow, by giving an instruction therefor to the communication section 303 according to the determination in the step S1204.

In the step S1207, the job flow list management section 306 causes the status and remaining number of times of execution of the job flow which are determined in the step S1204 to be reflected on the target job flow setting and update the job flow list 307.

Thus far described is the status-checking communication process executed in the step S1101 appearing in FIG. 11.

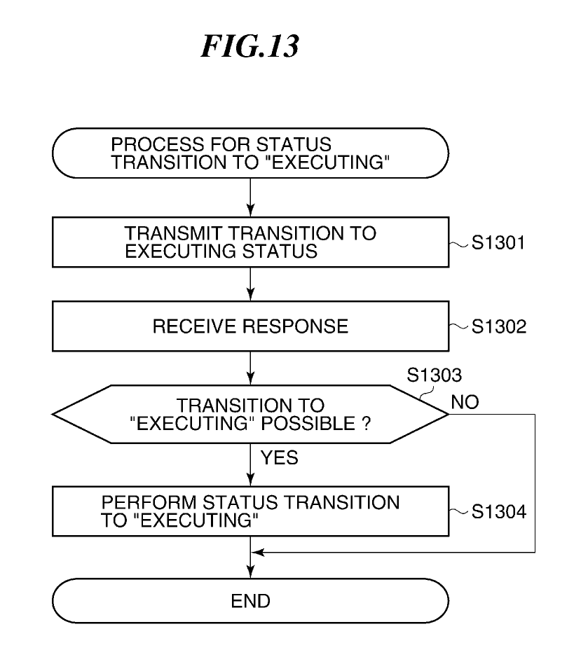

FIG. 13 is a flowchart of the process for status change to “executing”, which is executed in the step S1103 appearing in FIG. 11.

The process for status change to “executing” is realized mainly by a program of the job flow list management section 306.

In a step S1301, the job flow list management section 306 gives an instruction to the communication section 303 to perform a status-synchronizing communication process prior to causing transition of the status of the job flow to “executing”. More specifically, the job flow list management section 306 instructs the communication section 303 to cause the status transition of the job flow of the job flow setting in the other associated digital multi-function peripherals to “locked”.

The communication section 303 sends a request that the status of the job flow be set to “locked” to the multicast group address described in the job flow log via the network interface 206. If unicast addresses are described in the job flow log, a similar communication is performed to each of the addresses.

If any of the digital multi-function peripherals having received the request is incapable of causing status transition of the job flow to “locked”, it responds to the digital multi-function peripheral from the request was sent. This process will be described hereinafter.

In a step S1302, the job flow list management section 306 waits for a certain time period to receive a response from any digital multi-function peripheral where the status transition to “locked” is impossible.

In a step S1303, the job flow list management section 306 determines whether or not a packet indicating the status transition to “locked” is impossible has been received in the step S1302. If such a packet has been received, the job flow list management section 306 determines that the status transition to the “executing” is not permitted and terminates the present process. If not, the process proceeds to a step S1304.

The step S1304 is a case where the status transition to “executing” is permitted, and hence the job flow list management section 306 sets the status of the target job flow setting to “executing” to update the job flow list 307.

Thus far described the process for status change to “executing” which is executed in the step S1103 appearing in FIG. 11.

As described above, the processes shown in FIGS. 11 to 13 make it possible to synchronize the status of a job flow with the status of the job flow in each of the other digital multi-function peripherals before executing the job flow.

As described heretofore, by synchronizing the job flow prior to execution thereof, even if the job flow has not been synchronized due to the power of a digital multi-function peripheral being off, the job flow is executed after the synchronization is performed. Therefore, it is possible to prevent the job flow from being executed in a state in which the status and remaining number of times of execution of the job flow are differ from those in other digital multi-function peripherals.

Next, a description will be given of a process which is executed by the digital multi-function peripheral 120, for receiving a status check request for checking a status of a job flow from the digital multi-function peripheral 110, and sending back a response indicative the status of the job flow.

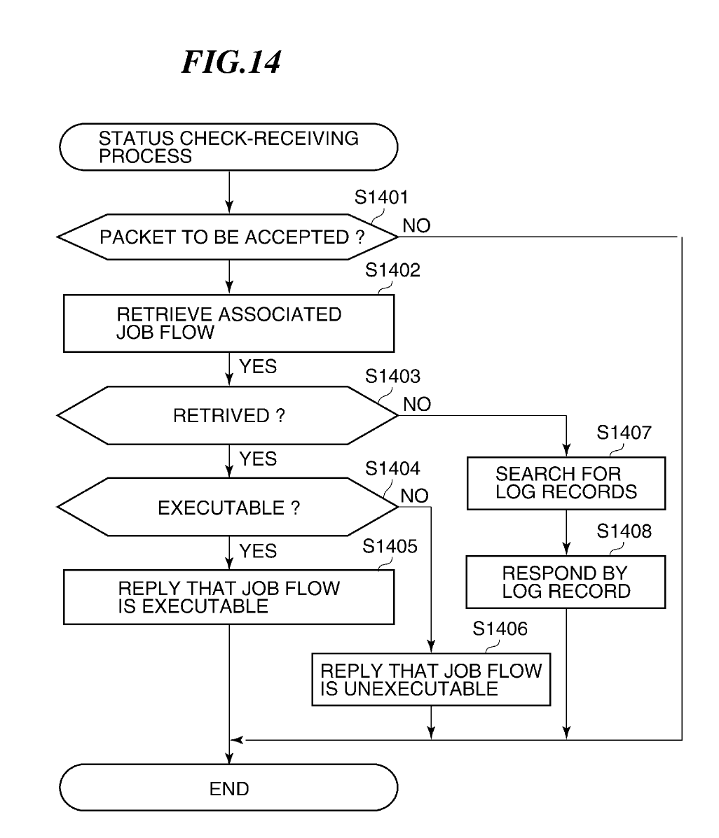

FIG. 14 is a flowchart of a status check-receiving process executed by the digital multi-function peripheral 120 appearing in FIG. 1 when a communication packet of a status check request is received as a result of the step S1202 appearing in FIG. 12 which is executed by the digital multi-function peripheral 110.

This status check-receiving process is realized mainly by a program of the job flow list management section 306.

In a step S1401, the communication section 303 receives the communication packet via the network interface 206 and determines whether or not the packet is to be accepted. The determination is made by determining whether or not the multicast group address belongs to the communication group list 304. In the case of unicast addresses, the determination is made by determining whether or not the source address belongs to the communication group list 304. If the communication section 303 determines that the packet is not to be accepted, the communication section 303 immediately terminates the process. If not, the process proceeds to a step S1402.

In the step S1402, the job flow list management section 306 inquires, using the address of the packet received in the step S1401, of the job flow list 307 for a job flow setting associated with the request to retrieve the same.

In a step S1403, the job flow list management section 306 determines whether or not the retrieval in the step S1402 is successful. If the retrieval is not successful, the process proceeds to a step S1407. If the retrieval is successful, the process proceeds to a step S1404.

In the step S1404, the job flow list management section 306 checks the status of the job flow retrieved in the step S1402 to determine whether or not the job flow is executable i.e. ready for execution. If the status is not “ready”, the job flow list management section 306 determines that the job flow is not executable, and the process proceeds to a step S1406. If not, the process proceeds to a step S1405.

In the step S1405, since the job flow is executable, the job flow list management section 306 notifies the source digital multi-function peripheral 110 from which the request was received that the job flow is executable. To this end, the job flow list management section 306 gives an instruction to the communication section 303 to cause the communication section 303 to perform communication for notifying that the job flow is executable, via the network interface 206.

In the step S1406, since the job flow is unexecutable, the job flow list management section 306 notifies the source digital multi-function peripheral 110 that the job flow is unexecutable.

In the step S1407, since the job flow setting is already deleted, the job flow list management section 306 makes an inquiry to the job flow log management section 309 for log records of the job flow associated with the status check request.

In a step S1408, the job flow list management section 306 notifies the digital multi-function peripheral 110 that the job flow is unexecutable, based on the result of the inquiry of log records in the step S1407. In other words, since this step is executed when the job flow setting has already been deleted, the latest one of the log records indicates that the log record type denoted by 502 in FIG. 5 is described as “delete”, and hence the job flow list management section 306 notifies the digital multi-function peripheral 110 that the job flow is unexecutable.

Thus far described is the status check-receiving process which is executed when the status of the job flow is inquired.

Next, a description will be given of a process executed by the digital multi-function peripheral 120 for receiving a synchronization notification of a job flow from the digital multi-function peripheral 110 and synchronizing the job flow.

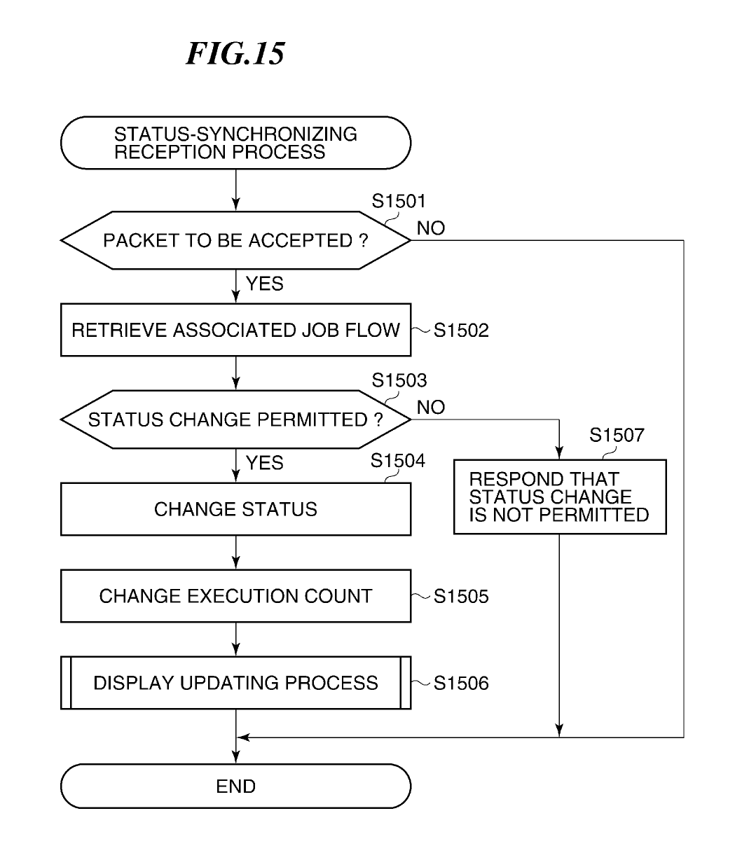

FIG. 15 is a flowchart of a status-synchronizing reception process executed by the digital multi-function peripheral 120 when a communication packet of status synchronization communication is received from the digital multi-function peripheral 110.

The status-synchronizing reception process is realized mainly by a program of the job flow list management section 306.

In a step S1501, similarly to the step S1401, the communication section 303 receives the communication packet via the network interface 206 and determines whether or not the packet is to be accepted.

If the communication section 303 determines that the packet is not to be accepted, the communication section 303 terminates the process. If not, the process proceeds to a step S1502.

In the step S1502, the job flow list management section 306 inquires, using the address of the packet received in the step S1501, of the job flow list 307 for a job flow setting associated with the packet to retrieve the same.

In a step S1503, the job flow list management section 306 determines whether or not the status of the job flow retrieved in the step S1502 can be changed. When the synchronization is for causing the job flow to be unexecutable, it is determined that the status of the job flow cannot be changed, if the job flow has already been deleted or the remaining number of times of execution of the job flow is zero, or when the job flow is not in the executable state.

In this case, the process proceeds to a step S1507, wherein the job flow list management section 306 causes the communication section 303 to send a reply that the job flow is not in the executable state, to the image processing apparatus 101, followed by terminating the present process. On the other hand, if the job flow is in an executable state, the process proceeds to a step S1504.

In the step S1504, the job flow list management section 306 changes the status of the job flow associated with the received packet to update the job flow list 307.

In a step S1505, the job flow list management section 306 changes the remaining number of times of execution of the job flow associated with the received packet to update the job flow list 307.

In a step S1506, since the status and remaining number of times of execution of the job flow are changed, the job flow list management section 306 performs the display updating process for the job flow, shown in FIG. 8. By executing this process, a job flow whose remaining number of times of execution becomes zero in the step S1505 is deleted.

By the above-described process, it is possible to synchronize the status and remaining number of times of execution of a job flow between digital multi-function peripherals that have received the same job flow.

In the present embodiment, although the same job flow is distributed to the digital multi-function peripheral 110 and the digital multi-function peripheral 120, by way of example, if the same job flow is distributed to e.g. the digital multi-function peripheral 130, it is also possible to synchronize the job flow in the digital multi-function peripheral 130.

Further, although in the present embodiment, synchronization is performed on the remaining number of times of execution, the present invention may also be accomplished by a similar configuration when the number of times of execution is only one.

Still further, each step of the present invention may also be accomplished by executing software (programs) obtained via a network or various types of storage media in a processing apparatus (CPU or processor thereof), including an image processing apparatus and an information processing apparatus.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-029903, filed Feb. 12, 2009, which is hereby incorporated by reference herein in its entirety.

What is claimed is:

1. An image processing apparatus comprising:
a reception unit configured to receive a job flow setting file in which a job flow to be executed is described;
an execution unit configured to execute the job flow based on the received job flow setting file; and
a notification unit configured to be operable when said execution unit executes the job flow, to notify other image processing apparatuses of execution of the job flow, and when said execution unit terminates the execution of the job flow, to notify the other image processing apparatuses of termination of the job flow.

2. The image processing apparatus according to claim 1, further comprising a determination unit configured to analyze a description of the job flow setting file received by said reception unit so as to determine whether or not a notification by said notification unit needs to be performed, and
wherein said notification unit is configured to be operable when said determination unit determines that the notification by said notification unit needs to be performed, to perform the notification.

3. The image processing apparatus according to claim 2, wherein said determination unit is configured to analyze whether or not a number of times of execution is described in the job flow setting file received by said reception unit, to thereby determine whether or not the notification by said notification unit needs to be performed.

4. The image processing apparatus according to claim 1, wherein the other image processing apparatuses are image processing apparatuses that store the job flow setting file.

5. The image processing apparatus according to claim 1, further comprising a checking unit configured to be operable when said execution unit executes the job flow, to check a status of the job flow in the other image processing apparatuses, and
wherein said execution unit is configured to execute the job flow depending on a result of checking by said checking unit.

6. The image processing apparatus according to claim 1, wherein the job flow setting file is created in an information processing apparatus and sent from the information processing apparatus to the image processing apparatus and the other image processing apparatuses.

7. A method of controlling an image processing apparatus, comprising:
receiving a job flow setting file in which a job flow to be executed is described;
executing the job flow based on the received job flow setting file; and
notifying, when executing the job flow, other image processing apparatuses of execution of the job flow, and notifying, when terminating the execution of the job flow, the other image processing apparatuses of termination of the job flow.

8. A computer-readable storage medium which stores a program for causing a computer to execute a method of controlling an image processing apparatus,
wherein the method comprises:
receiving a job flow setting file in which a job flow to be executed is described;
executing the job flow based on the received job flow setting file; and
notifying, when executing the job flow, other image processing apparatuses of execution of the job flow, and notifying, when terminating the execution of the job flow, the other image processing apparatuses of termination of the job flow.
